(19) United States
(12) Patent Application Publication
(10) Pub. No.: US 2015/0047629 A1
(43) Pub. Date: Feb. 19, 2015

(54) COUNTER-CURRENT DIFFUSER TECHNOLOGY FOR PRETREATMENT OF LIGNOCELLULOSIC SUBSTRATES

(71) Applicant: BP Corporation North America Inc., Naperville, IL (US)

(72) Inventors: Jacob Borden, San Diego, CA (US); James B. Garrett, San Diego, CA (US); John W. Shabaker, Naperville, IL (US)

(21) Appl. No.: 14/363,384

(22) PCT Filed: Dec. 5, 2012
(86) PCT No.: PCT/US2012/067827

§ 371 Date: Jun. 6, 2014

Related U.S. Application Data
(60) Provisional application No. 61/567,449, filed on Dec. 6, 2011.

(51) Int. Cl. C08B 1/00

(52) U.S. Cl. CPC C08B 1/003
USPC 127/1

(57) ABSTRACT

Methods, hydrolyzing diffuser units, and/or biorefineries suitable for use in biofuel production. A method of pre-treating biomass for production of biofuels includes contacting a biomass stream countercurrently with a pretreatment solution stream, and producing a hydrolyzate stream and a pretreated biomass stream. A hydrolyzing diffuser unit includes a series of stages, with an inlet for biomass in one stage and an inlet for a pretreatment solution in another stage, and systems for continually moving biomass, a system that continually withdraws the pretreatment solution to produce a hydrolyzate stream, and a system that continually withdraws pretreated biomass to produce a pretreated biomass stream. A biorefinery includes a hydrolyzer diffuser unit, a saccharification unit, and a conversion unit.

### BACKGROUND

1. Technical Field

The invention is directed to methods, counter-current diffuser units and other reactor configurations, lignocellulose pretreatment, and/or biorefineries suitable for use in biofuel production.

2. Background

Biofuels can be derived from a variety of feedstocks, including lignocellulosic biomass. Lignocellulosic biomass refers to plant biomass that is composed of cellulose, hemicellulose, and lignin. Lignocellulose pretreatment systems are used to increase the susceptibility of the lignocellulose to subsequent hydrolysis and extraction steps. Such pretreatment systems may involve pulverizing, shredding, milling, heating, sonicating, irradiating, pressurizing, hydrolyzing, and/or chemically treating the lignocellulose.

For example, existing unit operations for acid hydrolysis of lignocellulose utilize dilute mineral acid (1-3% wt/wt) as catalyst and steam (150-200° C. saturated) as heat-transfer medium in order to effect hydrolysis of hemicellulose and/or cellulosic lignocellulose fractions. Dilute acids are typically pre-mixed with solid lignocellulose, and the acid-laden slurry is then heated to the reaction temperature by direct steam injection. These components are typically co-fed into one end of a hydrolysis reactor, such as a screw conveyor.

Several issues are common among typical co-current reactor configurations. For instance, high-pressure solid screws are needed to overcome the inlet pressure barrier from inlet-injected steam. Additionally, the favoring of monomer degradation to aldehydes is troublesome as the reaction proceeds and monomers are formed late in the reactor. Also, there is the drawback of increased steam consumption due to the co-fed design.

In the sugar industry, diffuser technology is finding wider acceptance in the extraction of sucrose from shredded sugar cane. A diffuser is essentially a counter-flow aqueous extraction system, with shredded sugar cane fed in one end and liquid hot water fed in the other end. Liquid is continually withdrawn from stage n+1 for application to the n stage, while at the same time sugar cane moves from stage n to stage n+1. Meanwhile, the combined water and sugar cane are compressed and macerated within the diffuser. Aqueous sucrose is removed through one output while residual sugar cane bagasse is simultaneously removed through another output. The more the sugar cane is broken down, the greater the extraction yield. Consequently, an increase in the breakdown of biomass would result in an increase of feedstock for producing biofuels and, hence, a greater yield of biofuel production.

In summary, conventional diffuser technology is limited to counter-current, aqueous extraction of soluble sugars from shredded sugar cane in the sugar industry. Moreover, conventional pretreatment technology is limited to co-current hydrolysis of insoluble polysaccharides. There is thus a need and desire for improved methods and systems for the pretreatment of lignocellulosic biomass.

### SUMMARY

The invention is directed to methods, counter-current diffuser units and other reactor configurations, lignocellulose pretreatment, and/or biorefineries suitable for use in biofuel or other renewable material production.

According to some embodiments, the invention is directed to a method of pre-treating biomass. The method includes contacting a biomass stream countercurrently with a pretreatment solution stream, and producing both a hydrolyzate stream and a pretreated biomass stream.

According to some embodiments, the biomass stream includes a lignocellulosic material. According to some embodiments, the lignocellulosic material may comprise cellulose, hemicellulose, lignin, or any combination of these materials.

According to some embodiments, the pretreatment solution stream may include an acid or a base. For example, the acid may include an inorganic acid, an organic acid, an amino acid, a mineral acid, a Bronsted acid, a Lewis acid, or any combination of these acids. More particularly, the acid may be sulfuric acid, sulfonic acid, phosphoric acid, nitric acid, acetic acid, lactic acid, formic acid, oxalic acid, succinic acid, levulinic acid, carbonic acid, glycolic acid, uronic acid, glucaric acid, hydrofluoric acid, boric acid, boron trifluoride, or any combination of these acids. As a further example, the base may include an inorganic base, an organic base, a mineral base, a Bronsted base, a Lewis base, or any combination of these bases. More particularly, the base may be ammonia, ammonium hydroxide, sodium hydroxide, potassium hydroxide, calcium hydroxide, carbonates, amines, urea, or any combination of these bases.

According to some embodiments, the hydrolyzate stream may contain greater than about 30% by weight of the original biomass.

According to some embodiments, the pretreated biomass stream may have an enzymatic digestibility of cellulose greater than about 70%.

According to some embodiments, the countercurrent contacting may occur in multiple interaction zones.

According to some embodiments, the pretreatment solution may have a concentration between about 0.01% and about 10% on a mass basis.

According to some embodiments, the method may further include heating the pretreatment solution to a temperature between about 100 and about 180° C.

According to some embodiments, the method includes carrying out the countercurrent contacting in a hydrolyzing diffuser unit, with the biomass having a residence time inside the diffuser unit between about 1 and about 60 minutes.

According to some embodiments, the method further includes converting the biomass to one or more sugars. For example, the sugars may include sucrose, glucose, fructose, mannose, galactose, xylose, arabinose, hexose, pentose, cellobiose, oligosaccharides, or any combination of these sugars.

According to some embodiments, the method may include converting the sugars into a renewable material or other product. For example, the product may include ethanol, ethylene, n-butanol, isobutanol, 2-butanol, butenes, isobutene, isoprenoids, triglycerides, lipids, fatty acids, lactic acid, acetic acid, propanediol, butanediol, formic acid, levulinic acid, furfural, 5-hydroxymethyl furfural, acetone-butanol-ethanol, acetone, amino acids, or any combination of these materials.

According to some embodiments, the invention is directed to a hydrolyzing diffuser unit. The unit may include a series of stages ranging from stage n to stage n+z, wherein stage n includes an inlet for biomass and stage n+z includes an inlet for a pretreatment solution. The unit may also include a system that continually moves biomass from stage n to stage n+1, a system that continually moves biomass from stage n+z to stage n+z−1, a system that continually withdraws the pretreatment solution from stage n+y, thereby producing a hydrolyzate stream, and a system that continually withdraws pretreated biomass from stage n+m, thereby producing a pretreated biomass stream.

According to some embodiments, with respect to the hydrolyzing diffuser unit, n≧1, n≦z≦n+20, 0≦y≦z−1, and m≦z.

According to some embodiments, the system moves the biomass at a rate that provides the biomass with a residence time inside the diffuser unit between about 1 and about 60 minutes.

According to some embodiments, the hydrolyzing diffuser unit also includes a device for controlling pressure within each stage.

According to some embodiments, the diffuser unit may be adapted for use with an alkaline or acidic pretreatment solution.

According to some embodiments, the invention is directed to reactor configurations that allow for modified flow of lignocellulose, acid, and/or steam, or other heat-transferring medium. More particularly, these reactor configurations allow for decreasing temperature, increasing acid concentration, and/or counter-current flow as the lignocellulose material moves from the reaction inlet to the outlet.

According to some embodiments, the invention is directed to a biorefinery for producing biofuels. The biorefinery may include a hydrolyzer diffuser unit, a saccharification unit for converting the biomass to a sugar; and a conversion unit for producing a renewable material from the sugar.

### BRIEF DESCRIPTION OF THE DRAWINGS

The accompanying drawings, which are incorporated in and constitute a part of this specification, illustrate embodiments of the invention and, together with the description, serve to explain the features, advantages, and principles of the invention. In the drawings:

FIG. 1 illustrates a hydrolyzing diffuser unit, according to some embodiments;

FIG. 2 is a graphical representation of temperature and acid concentration along the length of a co-currently fed pretreatment reactor;

FIG. 3 illustrates a reaction pathway showing the kinetics of hemicellulose hydrolysis to monomer sugars (k₁) and subsequent degradation of sugars to aldehydes (k_{D});

FIG. 4 is a graphical representation of the impact of acid concentration and reaction temperature on the empirically estimated ratio of k₁/k_{D};

FIG. 5 illustrates a twin-channel screw conveyor, according to some embodiments;

FIG. 6 illustrates a two-stage pretreatment system, according to some embodiments;

FIG. 7 illustrates a reactor that uses gravity-settling of lignocellulose with up-flow of pre-heated acid catalyst, according to some embodiments;

FIG. 8 illustrates a system of mixing and settling tanks used for counter-flowing solid-liquid separations, according to some embodiments; and

FIG. 9 illustrates a biorefinery, according to some embodiments.

### DETAILED DESCRIPTION

The invention is directed to methods, counter-current diffuser units and other reactor configurations, lignocellulose pretreatment, and/or biorefineries suitable for use in biofuel production. According to some embodiments, the intended application of diffuser technology used in the sugar industry is altered for use in biofuel production. According to some embodiments, chemistry of the liquid hot water stream used in diffuser technology is altered for improved breakdown of biomass. According to some embodiments, both the intended application of diffuser technology and chemistry of the liquid hot water stream used in diffuser technology are altered for improved breakdown of biomass.

According to some embodiments, diffuser technology used in the sugar industry can be altered for use in biofuel production with lignocellulosic biomass as the feed. With this approach, the diffuser effects lignocellulosic pretreatment, which makes the biomass amenable to further enzymatic hydrolysis to monomer sugars. By feeding sugar cane bagasse or other lignocellulosic biomass rather than shredded sugar cane into a diffuser, the diffuser can disrupt the heteropolymer matrix that makes up lignocellulose, making the lignocellulosic biomass more amenable to enzyme hydrolysis for monomer sugar recovery.

More particularly, according to some embodiments, biomass pretreatment for the production of biofuels can be carried out by contacting a biomass stream countercurrently with a pretreatment solution stream, and producing a hydrolyzate stream and a pretreated biomass stream. A hydrolyzing diffuser unit, described in detail below, can be used to carry out this process. The biomass stream may include a lignocellulosic material, which may include, for example, cellulose, hemicellulose, lignin, or combinations of any of these materials.

According to some embodiments, the pretreatment solution stream may be a stream of hot water, as used in conventional diffuser technology used in the sugar industry. However, as mentioned above, the chemistry of the liquid hot water stream used in diffuser technology may be altered for improved breakdown of biomass. More particularly, according to some embodiments, the water stream may be alkaline or acidic, which results in improved pretreatment of lignocellulosic biomass. For example, the pretreatment solution may have a concentration between about 0.01% and about 10%, or between about 0.01% and about 5%, on a mass basis.

According to some embodiments, the pretreatment solution stream may include an acid such as an inorganic acid, an organic acid, an amino acid, a mineral acid, a Bronsted acid, a Lewis acid, or a combination of any of these acids. More particularly, in certain embodiments, the acid may be sulfuric acid, sulfonic acid, phosphoric acid, nitric acid, acetic acid, lactic acid, formic acid, oxalic acid, succinic acid, levulinic acid, carbonic acid, glycolic acid, uronic acid, glucaric acid, hydrofluoric acid, boric acid, boron trifluoride, or a combination of any of these acids.

According to some embodiments, the pretreatment solution stream may include a base such as an inorganic base, an organic base, a mineral base, a Bronsted base, a Lewis base, or a combination of any of these bases. More particularly, in certain embodiments, the base may be ammonia, ammonium hydroxide, sodium hydroxide, potassium hydroxide, calcium hydroxide, carbonates, amines, urea, or a combination of any of these bases.

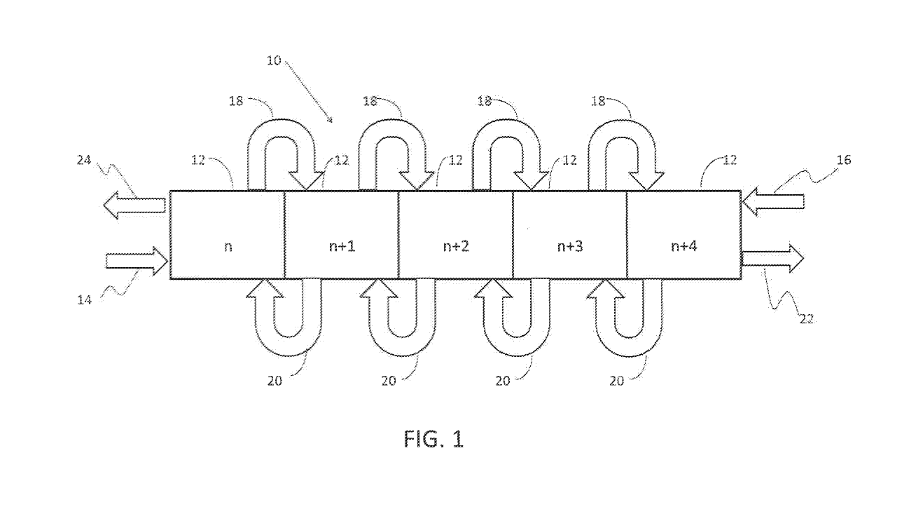

According to some embodiments, the biomass pretreatment, more particularly the countercurrent contact of the biomass with the pretreatment solution stream, may be carried out in a hydrolyzing diffuser unit, such as the hydrolyzing diffuser unit 10 illustrated in FIG. 1. As shown in FIG. 1, the hydrolyzing diffuser unit 10 includes a series of stages 12 ranging from stage n to stage n+z. Stage n includes an inlet 14 for biomass and stage n+z includes an inlet 16 for a pretreatment solution. The hydrolyzing diffuser unit 10 also includes a system 18 that continually moves biomass from stage n to stage n+1, as well as a system 20 that continually moves pretreatment solution from stage n+z to stage n+z−1, thus creating the countercurrent contact through multiple interaction zones. Additionally, the hydrolyzing diffuser unit 10 includes a system that continually withdraws the pretreatment solution from stage n+y, thereby producing a hydrolyzate stream 24, and a system that continually withdraws pretreated biomass from stage n+m, thereby producing a pretreated biomass stream 22. The hydrozylate stream may contain greater than about 20%, or even greater than about 30% by weight of the original biomass. The pretreated biomass stream may have an enzymatic digestibility of cellulose greater than about 60%, or even greater than about 70%. The variables used herein may have the following ranges of values:
n≧1
n≦z≦n+20
0≦y≦z−1
m≦z

Other embodiments, apart from the hydrolyzing diffuser unit 10 illustrated in FIG. 1, are included in the scope of this invention. For example, the hydrolyzing diffuser unit 10 may be combined with one or more other diffuser units. More particularly, as an example, a conventional diffuser may be extended to include a new counter-current section for acid pretreatment. In such an embodiment, the variables used above may not accurately describe the system, but the manner of carrying out the counter-current contact is fundamentally the same.

In some embodiments, the hydrolyzing diffuser unit, or countercurrent section, includes a series of stages ranging from a first stage to a final stage, with one or more intermediate stages therebetween. The first stage includes an inlet for biomass and the final stage includes an inlet for a pretreatment solution. The unit also includes a system that continually withdraws the pretreatment solution from an intermediate stage and feeds the pretreatment solution into the first stage thereby producing a hydrolyzate stream, while simultaneously moving biomass from the first stage to an intermediate stage thereby producing a pretreated biomass stream.

According to some embodiments, the biomass may have a residence time inside the hydrolyzing diffuser unit 10 between about less than 1 and about 90 minutes, measured from the time the biomass enters the inlet 14 until the pretreated biomass stream 22 produced from the same biomass exits stage n+y. Residence time of the biomass within the hydrolyzing diffuser unit 10 is dependent upon the rate at which the system 18 moves biomass from stage n to stage n+1.

According to some embodiments, the pretreatment solution may have a residence time inside the hydrolyzing diffuser unit 10 between about less than 1 and about 120 minutes, measured from the time the pretreatment solution enters the inlet 16 until the hydrolyzate stream 24 exits stage n+y. Residence time of the pretreatment solution within the hydrolyzing diffuser unit 10 is dependent upon the rate at which the system 20 moves pretreatment solution from stage n+z to stage n+z−1. In some embodiments, the biomass residence time is the same as the pretreatment solution residence time. In other embodiments, the pretreatment solution residence time is greater than the biomass residence time, and in other embodiments the pretreatment solution residence time is less than the biomass residence time.

The pretreatment solution may be heated to a temperature between about 100 and about 180° C. within the hydrolyzing diffuser unit 10 to assist in breaking down the biomass. Heat can be supplied by steam, saturated steam, super heated steam, hot water, glycol, heat transfer oil, heat transfer fluid, other process streams, and/or the like. Temperature control can use any suitable technique and/or configuration, such as indirect heat exchange, direct heat exchange, convection, conduction, radiation, and/or the like.

Additionally or alternatively, the hydrolyzing diffuser unit 10 may include a device for controlling pressure within each of the stages 12. For example, when using dilute aqueous ammonia as the pretreatment solution, as the dilute aqueous ammonia moves from stage n+1 to stage n, the pressure within each stage 12 can be used to control the amount of aqueous-phase ammonia, and thereby allow for tuning of the pretreatment severity and efficacy.

As used herein, the terms “stage” and “zone” can be used interchangeably to refer to a single step or area in a process, which can be separated by other steps or areas by time and/or distance.

The hydrolyzing diffuser unit 10 may be adapted for use with an alkaline or acidic pretreatment solution. For example, the hydrolyzing diffuser unit 10 may be formed primarily of a high-alloy material, such as Hastelloy®, which is commercially available from Haynes International, Inc. of Kokomo, Ind.; Incoloy®, which is commercially available from Huntington Alloys Corporation of Huntington, W. Va.; alloy AL-6XN® (N08367), which is commercially available from Allegheny Ludlum Corporation of Pittsburgh, Pa.; MC Alloy, which is commercially available from MMC Superalloy of Saitama, Japan; Alloy 926 (N08926), which is commercially available from M. Woite GmbH of Erkrath, Germany; Alloy G (N06007), Alloy 20Cb-3® (N08020), Alloy 255 (S39255), 7Mo-PLUS (S32950), Alloy 59 (N06059), and Nickel 200 (N02200), each of which is commercially available from a variety of vendors; titanium-stabilized alloys, zirconium-stabilized alloys, silicon-stabilized alloys, chromium-stabilized alloys, nickel-stabilized alloys, molybdenum-stabilized alloys, copper-stabilized alloys, and combinations of any of these materials.

According to some embodiments, during or following pretreatment in the hydrolyzing diffuser unit 10, the biomass may be converted to one or more sugars, such as sucrose, glucose, fructose, mannose, galactose, xylose, arabinose, hexose, pentose, cellobiose, oligosaccharides, or combinations of any of these sugars. In certain embodiments, the sugar or sugars may subsequently be converted into a renewable material or other product. The product may include, for example, methane, methanol, ethanol, ethylene, n-butanol, isobutanol, 2-butanol, butenes, isobutene, isoprenoids, triglycerides, lipids, fatty acids, lactic acid, acetic acid, propanediol, butanediol, formic acid, levulinic acid, furfural, 5-hydroxymethyl furfural, acetone, amino acids, or any combination of these materials.

Other pretreatment reactor configurations that allow for modified flow of lignocellulose, acid, and/or steam, or other heat-transferring medium, are also contemplated herein. These reactor configurations allow for decreasing temperature, increasing acid concentration, and/or counter-current flow as the lignocellulose material moves from the reaction inlet to the outlet.

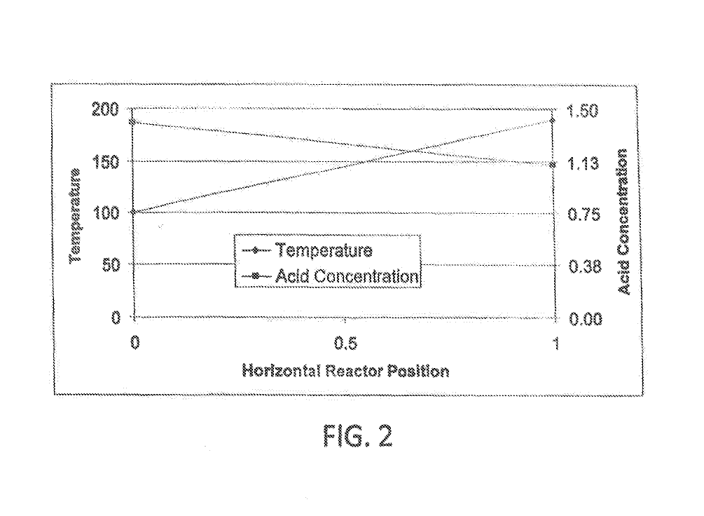

In certain embodiments, steam condensation provides the majority of heat transfer to the solid lignocellulose. As the steam and lignocellulose mix, steam condenses and the lignocellulose/acid slurry rises in temperature along the length of the reactor. This condensing steam effectively dilutes the mineral-acid catalyst as the reacting slurry progresses along the length of the reactor. The graph in FIG. 2 depicts an over-simplified (linear) profile of temperature and acid concentration along the length of the reactor, wherein 0 is the reactor inlet, and 1 is the reactor outlet.

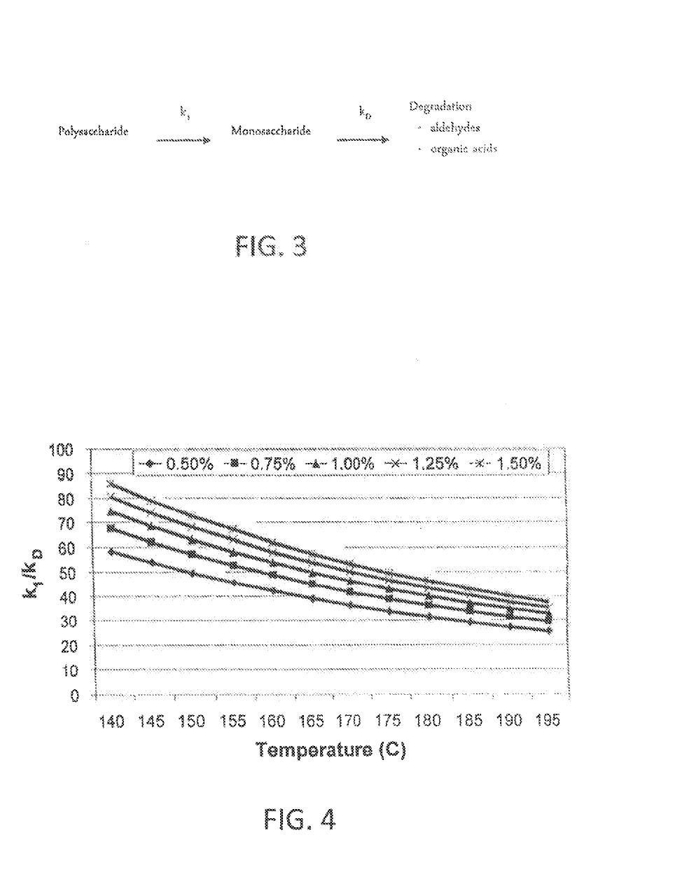

However, available data on the kinetics of hemicellulose hydrolysis to monomer sugars (k₁) and subsequent degradation of sugars to aldehydes (k_{D}) suggests that increasing reactor temperature and decreasing acid concentration along the length of the reactor favors the formation of aldehydic degradation products. FIG. 3 illustrates a reaction pathway showing k₁ and k_{D} in the path of degrading polysaccharides to monosaccharides (k₁) and further from monosaccharides to degradants (k_{D}). Additionally, the graph in FIG. 4 shows the impact of acid concentration and reaction temperature on the empirically estimated ratio of k₁/k_{D}.

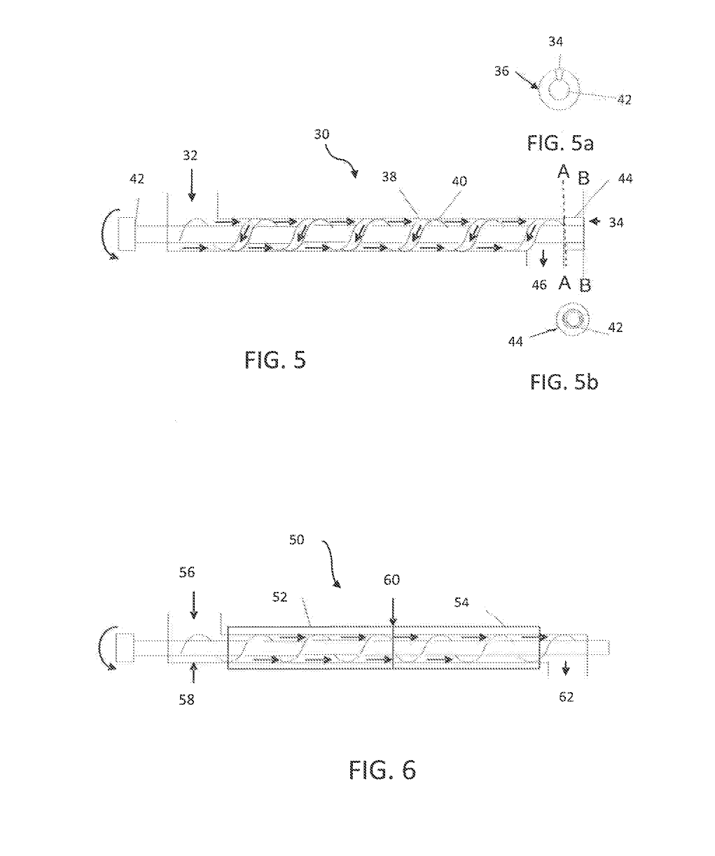

According to some embodiments, a twin-channel screw conveyor 30 may be used for continuous counter-current steam addition. An example of a twin-channel screw conveyor 30 is illustrated in FIG. 5. In this configuration, lignocellulose is optionally mixed with pretreatment solution and fed into a feedstock inlet 32 at one end of the screw conveyor 30. Steam is then injected into an annulus inlet 34 through a rotating annulus plate 36 at the opposite end of the reactor 30 and flows backwards through double-annulus spiral winds 38, 40, counter-current relative to the forward-progressing lignocellulose. The spiral winds 38, 40 encircle a drive shaft 42. FIG. 5a is a cross-sectional view of the annulus plate 36 taken along line A-A in FIG. 5. One of the spiral winds 40 may be fabricated with perforations, such as made out of metal meshing or a solid material with holes formed therein, to allow direct steam injection in the forward-flowing lignocellulose. Steam is injected into an inlet box 44 and flows into the annulus inlet 34 in the rotating annulus plate 36 and finally into the twin-screw spacing, where the steam flows counter-current to the forward-progressing lignocellulose. FIG. 5b is a cross-sectional view of the inlet box 44 taken along line B-B in FIG. 5. The pretreated lignocellulose and hydrolyzate then exits through an outlet 46. The annulus width and the spacing, size, and location of perforations for steam injection along the length of the reactor can all be manipulated to optimize the rate, location, and overall extent of steam-induced heating. The counter-current injection of steam allows for lower steam injection and less of a front-end pressure barrier to solids addition compared to conventional reactors.

Additional permutations to the design illustrated in FIG. 5 include the use of multiple pretreatment solution injection points, and multiple steam addition taps along the length of the reactor rather than the internal annulus for direct steam injection. Also, steam heating without direct steam injection could be achieved by condensing the steam in an internal annulus that does not have perforations. Condensate would be drained from the internal annulus upstream of the lignocellulose acid addition point.

According to some embodiments, two-stage pretreatment may be carried out using a steam/acid addition stage followed by a cooling/acid addition stage. An example of a two-stage pretreatment system is illustrated in FIG. 6. In this configuration, a reactor 50 is divided into two zones, namely a high-temperature zone 52 followed by a low-temperature zone 54 with additional acid feed. For example, the high-temperature zone 52 may maintain a temperature in a range between about 140 and about 180° C., while the low-temperature zone 54 may maintain a temperature in a range between about 100 and about 160° C., with the temperature in the high-temperature zone 52 exceeding the temperature in the low-temperature zone 54. In the high-temperature zone 52, pre-mixed lignocellulose and acid are fed co-currently with superheated steam. The pre-mixed lignocellulose and acid may be fed through a first inlet 56 while the superheated steam is fed either through the first inlet 56 or another inlet 58 in close proximity to the first inlet. The steam condenses and heats the lignocellulose/acid slurry as described in previous embodiments. This hot reaction zone is followed by the addition of cold aqueous acid through a second inlet 60, which serves to both quench the reacting lignocellulose/acid slurry as well as increase the acid concentration. For example, the high-temperature zone 52 may comprise acid concentration in a range between about 0 and about 2 wt % acid, while the low-temperature zone after acid quenching may comprise acid concentration in a range between about 0 and about 5 wt % acid. The high-temperature reaction zone 52 serves to begin the rapid break-down of polymeric hemicelluloses to oligomers, while the low-temperature reaction zone 54 allows residence time for full hydrolysis to monomers while at conditions more favorable for hydrolysis to monomers than degradation of monomers to aldehydes. Downstream of the low-temperature zone 54, the hydrolyzed biomass exits the reactor 50 through an outlet 62.

Additional permutations to the design illustrated in FIG. 6 include the separation of the above reactor 50 into two physically separate reactors, potentially including a solid/liquid separation system in between for removal of hydrolyzed carbohydrate and greater concentrating/cooling impact of the quenching acid. Also, thermal quenching in the low-temperature zone 54 may be through directed heat transfer as discussed in other embodiments. Yet another embodiment comprises the use of multiple acid quenching ports 60 along the length of the pretreatment reactor.

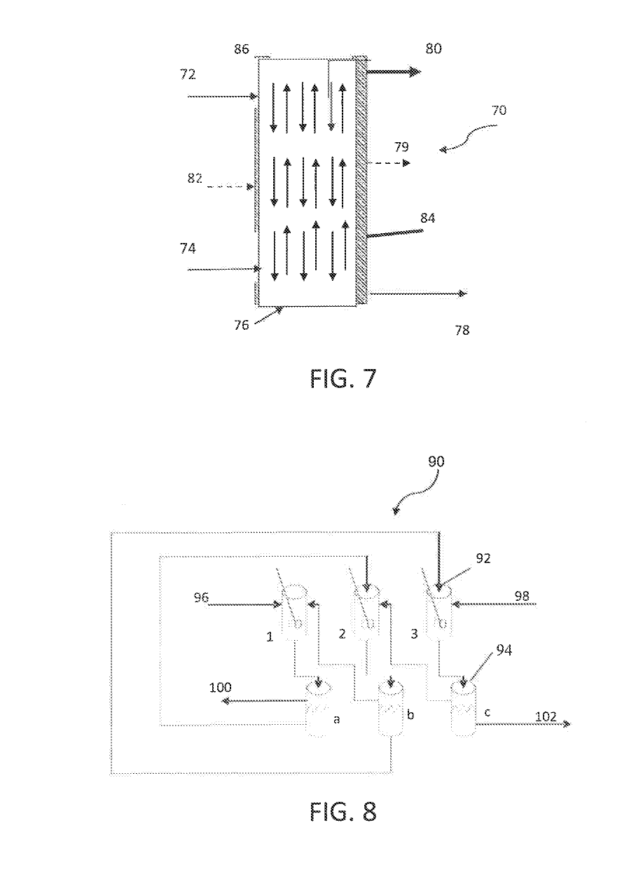

According to some embodiments, gravity-settling of lignocellulose may be used with up-flow of pre-heated acid catalyst. An example of such a reactor 70 is illustrated in FIG. 7. In this configuration, solid lignocellulose is fed into a first inlet 72 at or near the top end of a counter-current reactor 70. Pretreatment solution is injected into a second inlet 74 near the bottom end of the reactor 70 and flows upwards, counter to the gravity-induced downward motion of the solid lignocellulose. At the bottom end of the reactor 70, below the port 74 for acid addition, a conveyor 76 continuously removes pretreatment solid lignocellulose from the reactor 70 through an outlet 78. Meanwhile, hydrolyzate is removed through an outlet 80 at or near the top end of the reactor 70. This design allows for counter-current flow of solid lignocellulose and aqueous catalyst. As used herein, the term “top end” refers to approximately the top 25% of the height of the reactor. Similarly, as used herein, the term “bottom end” refers to approximately the bottom 25% of the height of the reactor. In certain embodiments, additional pretreatment solution can also be fed at multiple points 82 along the height of the reactor 70, and/or multi-zoned jacketing 84 around the reactor 70 can be used for heat transfer to control the temperature profile along the reactor height. For example, the jacketing 84 may include a steam inlet 86 for heating one or more zones of the reactor 70 along the reactor height. In yet another embodiment, pretreatment solution may be removed along the height of the reactor at one or more intermittent spent acid outlets 79.

In still other embodiments, the solid lignocellulose is fed at the inlet 74 at or near the bottom of a counter-current reactor 70, while pretreatment solution is injected into an inlet 72 near the top of the reactor. Thus, the reactor 70 illustrated in FIG. 7 may be used for either top-down feedstock flow for gravity-assisted feedstock flow, or bottom-up feedstock flow for gravity-assisted washing.

In embodiments wherein the biomass is moving upward and the liquid is moving downward, excess pressure, such as in the form of steam or compressed gas (for example, CO₂, N₂, or the like) can be used to force the liquid through the biomass thus decreasing the retention time of the liquid relative to the feedstock and increasing the permeability of the feedstock to the liquid.

According to some embodiments, a system 90 of mixing tanks 92 and settling tanks 94 may be used for counter-flowing solid-liquid separations. An example of such a system 90 is illustrated in FIG. 8.

In this configuration, lignocellulose and acid flow counter-currently into a series of mixing tanks 92 and settling tanks 94. Lignocellulose is introduced into a first mixing tank (mixing tank 1) through a first inlet 96 while acid is fed into a last mixing tank (mixing tank 3, in FIG. 8) through a second inlet 98. The lignocellulose in mixing tank 1 is mixed with aqueous acid from the aqueous phase of a second settling tank (settling tank b). The lignocellulose/acid slurry is continuously fed from mixing tank 1 into settling tank a, and the aqueous phase removed from settling tank a through an acid outlet 100 while the solid fraction is fed into mixing tank 2. Counter-current flow of acid and lignocellulose can progress into any number of mixing and settling tanks as required for sufficient residence time, with the hydrolyzed lignocellulose exiting the system through an outlet 102 in the final settling tank of the series. Additionally, the aqueous acid can be cooled or heated as it is fed from settling tank to the next mixing tank, so as to tailor the reaction kinetics within each vessel to favor carbohydrate hydrolysis reaction rate and/or minimize formation of aldehyde degradation products. This design also allows for simplified acid addition and/or removal of spent acid anywhere along the system.

In certain embodiments, applied to essentially any of the reactor configurations described herein, a water-permeable membrane may be used between the various tanks, units, or zones for aiding in reconcentration of acid streams. Alternatively, reconcentration of acid streams may be accomplished with distillation.

In certain reactor embodiments, particularly the gravity-settling reactor 70 illustrated in FIG. 7 or the system 90 of mixing tanks 92 and settling tanks 94 illustrated in FIG. 8, an ionic membrane may be used to remove acid from biomass hydrolyzate before degradation.

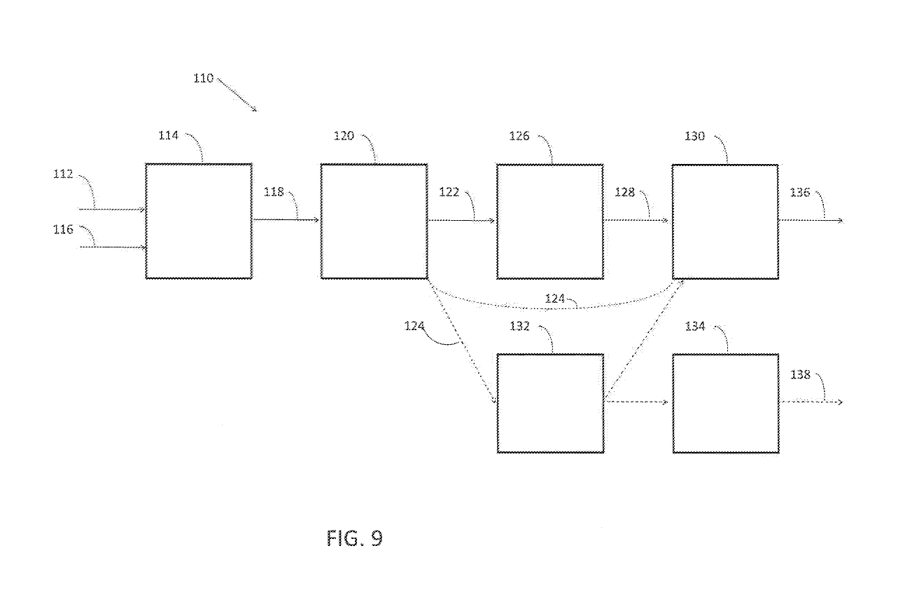

FIG. 9 illustrates a biorefinery 110, according to one embodiment. The biorefinery 110 includes a feedstock line 112 connected to a lignocellulose pretreatment unit 114, such as for supplying lignocellulosic material. The biorefinery 110 also includes a pretreatment solution line 116 connected to the pretreatment reactor unit 114, such as for supplying a pretreatment solution. The pretreatment reactor unit 114 breaks down or depolymerizes the lignocellulosic material and may include any suitable pretreatment steps, processes, and/or devices, which then produces a pretreatment stream 118. The pretreatment may include chemical, mechanical, and/or thermal processing including use of acids and/or bases, such as to convert polysaccharides into monosaccharides. For instance, the pretreatment reactor unit 114 breaks down or depolymerizes the cellulose into glucose, and the hemicelluloses into xylose. In certain embodiments, the pretreatment reactor unit 114 may be adapted for use with an alkaline or acidic pretreatment solution.

According to some embodiments, the pretreatment stream 118 may be connected to a liquid-solid separation unit 120 to generate a pretreated biomass stream 122 and a hydrolyzate stream 124. For example, units for liquid-solid separation could comprise a filter, a membrane, a settling tank, or a screw-press.

The pretreated biomass stream 122 may additionally be connected to a saccharification unit 126 wherein the pretreated lignocellulosic material is converted to a sugar, which leaves the saccharification unit 126 in the form of a renewable-based feedstock stream 128. The renewable-based feedstock stream 128 connects to a conversion unit 130 to form a renewable material 136 or other product from the sugar. The renewable material 136 or other product may include ethanol, ethylene, n-butanol, isobutanol, 2-butanol, butenes, isobutene, isoprenoids, triglycerides, lipids, fatty acids, lactic acid, acetic acid, propanediol, butanediol, formic acid, levulinic acid, furfural, 5-hydroxymethyl furfural, acetone-butanol-ethanol, acetone, amino acids, or any combination of these materials, for example.

The hydrolyzate stream 124 may be connected to the conversion unit 130. Alternatively, the hydrolyzate stream 124 may be connected to a conditioning unit 132 before feeding into the conversion unit 130 or an independent conversion unit 134 to produce renewable product 138, such as hydrocarbons, alcohols, poly-ols, sugar derivatives, organic acids, ketones, aldehydes, amines, or the like. Other configurations of the biorefinery 110 are within the scope of this invention.

Biorefinery broadly refers to a plant, an industrial complex, a collection of process units, and/or the like, such as used to produce a renewable material or other product.

Renewable material broadly refers to a substance and/or an item that has been at least partially derived from a source and/or a process capable of being replaced at least in part by natural ecological cycles and/or resources. Renewable materials may broadly include chemicals, chemical intermediates, solvents, monomers, oligomers, polymers, biofuels, biofuel intermediates, biogasoline, biogasoline blendstocks, biodiesel, green diesel, renewable diesel, biodiesel blend stocks, biodistillates, biochar, biocoke, renewable building materials, and/or the like. Desirably, but not necessarily, the renewable material may be derived from a living organism, such as plants, algae, bacteria, fungi, and/or the like.

Biofuel broadly refers to components and/or streams suitable for use as a fuel and/or a combustion source derived at least in part from renewable sources. The biofuel can be sustainably produced and/or have reduced and/or no net carbon emissions to the atmosphere, such as when compared to fossil fuels. According to some embodiments, renewable sources can exclude materials mined or drilled, such as from the underground. In some embodiments, renewable resources can include single cell organisms, multi-cell organisms, plants, fungi, bacteria, algae, cultivated crops, non-cultivated crops, timber, and/or the like. Biofuels can be suitable for use as transportation fuels, such as for use in land vehicles, marine vehicles, aviation vehicles, and/or the like. Biofuels can be suitable for use in power generation, such as raising steam, exchanging energy with a suitable heat transfer media, generating syngas, generating hydrogen, making electricity, and/or the like.

Biogasoline broadly refers to components and/or streams suitable for direct use and/or blending into a gasoline pool and/or octane supply derived from renewable sources, such as methane, hydrogen, syn (synthesis) gas, methanol, ethanol, propanol, butanol, dimethyl ether, methyl tert-butyl ether, ethyl tert-butyl ether, hexanol, aliphatic or olefinic compounds (straight, branched, and/or cyclic), heptane, isooctane, cyclopentane, aromatic compounds, ethyl benzene, and/or the like. Butanol broadly refers to products and derivatives of 1-butanol, 2-butanol, iso-butanol, other isomers, and/or the like. Biogasoline may be used in spark ignition engines, such as automobile gasoline internal combustion engines. According to one embodiment, the biogasoline and/or biogasoline blends meet or comply with industrially accepted fuel standards.

Biodiesel broadly refers to components and/or streams suitable for direct use and/or blending into a diesel pool and/or a cetane supply derived from renewable sources. Suitable biodiesel molecules can include fatty acid esters, monoglycerides, diglycerides, triglycerides, lipids, fatty alcohols, alkanes, naphthas, distillate range materials, paraffinic materials, aromatic materials, aliphatic compounds (straight, branched, and/or cyclic), and/or the like. Biodiesel can be used in compression ignition engines, such as automotive diesel internal combustion engines, truck heavy duty diesel engines, and/or the like. In the alternative, the biodiesel can also be used in gas turbines, heaters, boilers, and/or the like. According to some embodiments, the biodiesel and/or biodiesel blends meet or comply with industrially accepted fuel standards, such as B20, B40, B60, B80, B99.9, B100, and/or the like.

Biodistillate broadly refers to components and/or streams suitable for direct use and/or blending into aviation fuels (jet), lubricant base stocks, kerosene fuels, fuel oils, and/or the like. Biodistillates can be derived from renewable sources, and have any suitable boiling point range, such as a boiling point range of about 100° C. to about 700° C., about 150° C. to about 350° C., and/or the like.

Biomass broadly refers to biological material from living or recently living organisms, such as plant or animal matter.

Hydrolyzate broadly refers to a substance produced by hydrolysis.

Counter-current system broadly refers to a system in which two or more streams of material flow past one another in different directions. In contrast, a co-current system includes two or more streams of material that flow in the same direction.

Lignocellulosic broadly refers to containing cellulose, hemicellulose, lignin, and/or the like, such as may be derived from plant material and/or the like. Lignocellulosic material may include any suitable material, such as sugar cane, sugar cane bagasse, energy cane bagasse, rice, rice straw, corn, corn stover, wheat, wheat straw, maize, maize stover, sorghum, sorghum stover, sweet sorghum, sweet sorghum stover, cotton remnant, sugar beet, sugar beet pulp, soybean, rapeseed, jatropha, switchgrass, miscanthus, other grasses, timber, softwood, hardwood, wood waste, sawdust, paper, paper waste, agricultural waste, municipal waste, any other suitable biomass material, and/or the like.

Lignin broadly refers to a biopolymer that may be part of secondary cell walls in plants, such as a complex highly cross-linked aromatic polymer that may covalently link to hemicellulose.

Hemicellulose broadly refers to a branched sugar polymer composed mostly of pentoses, such as with a generally random amorphous structure and typically may include up to hundreds of thousands of pentose units.

Cellulose broadly refers to an organic compound with the formula (C₆H₁₀O₅)_{z} where z includes any suitable integer. Cellulose may include a polysaccharide with a linear chain of several hundred to over ten thousand hexose units and a high degree of crystalline structure, for example.

The scope of the invention is not limited merely to breakdown of biomass, but broadly may be applied to and/or used with other processes and/or applications.

As used herein the terms “having”, “comprising”, and “including” are open and inclusive expressions. Alternatively, the term “consisting” is a closed and exclusive expression. Should any ambiguity exist in construing any term in the claims or the specification, the intent of the drafter is toward open and inclusive expressions.

Regarding an order, number, sequence, and/or limit of repetition for steps in a method or process, the drafter intends no implied order, number, sequence, and/or limit of repetition for the steps to the scope of the invention, unless explicitly provided.

Regarding ranges, ranges are to be construed as including all points between upper and lower values, such as to provide support for all possible ranges contained between the upper and the lower values including ranges with no upper bound and/or lower bound.

It will be apparent to those skilled in the art that various modifications and variations can be made in the disclosed structures and methods without departing from the scope or spirit of the invention. Particularly, descriptions of any one embodiment can be freely combined with descriptions or other embodiments to result in combinations and/or variations of two or more elements or limitations. Other embodiments of the invention will be apparent to those skilled in the art from consideration of the specification and practice of the invention disclosed herein. It is intended that the specification and examples be considered exemplary only, with a true scope and spirit of the invention being indicated by the following claims.

1-51. (canceled)

52. A hydrolyzing diffuser unit comprising:
a series of stages ranging from stage n to stage n+z, wherein stage n comprises an inlet for biomass and stage n+z comprises an inlet for a pretreatment solution;
a system that continually moves biomass from stage n to stage n+1;
a system that continually moves pretreatment solution from stage n+z to stage n+z−1;
a system that continually withdraws the pretreatment solution from stage n+y, thereby producing a hydrolyzate stream; and
a system that continually withdraws pretreated biomass from stage n+m, thereby producing a pretreated biomass stream.

53. The diffuser unit of claim 52, wherein:
n≧1;
n≦z≦n+20;
0≦y≦z−1; and
m≦z.

54. The diffuser unit of claim 52, wherein the system moves the biomass at a rate that provides the biomass with a residence time inside the diffuser unit between about 1 and about 60 minutes.

55. The diffuser unit of claim 52, further comprising a device for controlling pressure within each stage.

56. The diffuser unit of claim 52, wherein the diffuser unit is adapted for use with an alkaline or acidic pretreatment solution.

57. The diffuser unit of claim 52, wherein the diffuser unit is combined with at least one other diffuser unit.

58. A reactor comprising:
a twin-channel screw conveyor having an inlet for biomass mixed with acid at a first end of the screw conveyor; an inlet for steam at a second end of the screw conveyor opposite the first end, wherein the steam flows counter-current to the biomass mixture; and an outlet for the steam-heated biomass mixture.

59. The reactor of claim 58, wherein the screw conveyor comprises an annulus at the second end for direct steam injection, and double-annulus spiral winds extending between the first end and the second end.

60. The reactor of claim 59, wherein a spiral wind comprising the inlet for steam at the second end of the screw conveyor is fabricated with perforations to allow steam injection into the forward-flowing biomass mixture.

61. The reactor of claim 58, wherein the screw conveyor comprises multiple steam addition taps along a length of the reactor.

62. The reactor of claim 58, wherein the screw conveyor comprises a non-perforated internal annulus in which the steam can condense.

63. A reactor comprising:
a high-temperature zone having a first inlet for biomass mixed with acid and steam;
a low-temperature zone downstream of the high-temperature zone, the low-temperature zone having a second inlet for cooled aqueous acid; and
an outlet for the biomass downstream of the low-temperature zone.

64. The reactor of claim 63, wherein the high-temperature zone and the low-temperature zone are housed in a single reactor.

65. The reactor of claim 63, wherein the high-temperature zone and the low-temperature zone are housed in two separate reactors, and further comprising a solid/liquid separation system between the two separate reactors with an outlet for hydrolyzed carbohydrate upstream of the low-temperature zone reactor.

66. A reactor comprising:
an inlet for biomass at or near a top end of the reactor;
an inlet for liquid acid catalyst near a bottom end of the reactor; and
a screw conveyor positioned below the inlet for the liquid acid catalyst, wherein the screw conveyor continuously removes pretreated biomass from the reactor through an outlet.

67. The reactor of claim 66, further comprising multiple inlets along the height of the reactor through which additional acid can be fed.

68. The reactor of claim 66, further comprising multi-zoned jacketing around the reactor providing heat transfer in order to control the temperature profile along the height of the reactor.

69. A reactor comprising:
an inlet for biomass at or near a bottom end of the reactor; and
an inlet for liquid acid catalyst near a top end of the reactor.

70. The reactor of claim 69, further comprising multiple inlets along the height of the reactor through which additional acid can be fed.

71. The reactor of claim 69, further comprising multiple outlets along the height of the reactor through which hydrolyzate solution can be removed.

72. The reactor of claim 69, further comprising multi-zoned jacketing around the reactor providing heat transfer in order to control the temperature profile along the height of the reactor.

73. The reactor of claim 69, further comprising an inlet for steam or compressed gas to force the liquid acid catalyst through the biomass.
